(19) United States
(12) Patent Application Publication
(10) Pub. No.: US 2011/0144786 A1
(43) Pub. Date: Jun. 16, 2011

(54) MATERIAL MANAGEMENT SYSTEM AND METHOD FOR RETOOLING AND PRODUCING A MANUFACTURING LINE

(75) Inventor: Ronald D. Pearce, Pontiac, MI (US)

(73) Assignee: GONZALEZ TECHNICAL SERVICES, INC., Madison Heights, MI (US)

(21) Appl. No.: 12/635,967

(22) Filed: Dec. 11, 2009

(51) Int. Cl. G06F 17/50; G06F 17/30

(52) U.S. Cl. 700/100; 707/792; 707/E17.044; 700/107

(57) ABSTRACT

A material management system and method for utilizing components from an existing manufacturing line to configure a predetermined manufacturing line is provided. The system and method includes an inventory, and an interface. The inventory is stored in a database and includes a list of components of existing manufacturing lines. A first processor is in communication with the database. The interface is operable to transmit information relating to the predetermined manufacturing line to the first processor so as to generate a list having all of the components needed to configure the predetermined manufacturing line. The first processor is further operable to process the inventory and identify all components in the inventory which are compatible for use in the predetermined manufacturing line and generate a list of compatible components. The interface is operable to selectively choose any component from the list of compatible components for use in the predetermined manufacturing line.

### BACKGROUND OF THE INVENTION

1. Field of the Invention

The present invention relates generally to a system and method for material management. More specifically, the present invention relates to a system and method for saving material and costs when retooling or producing a manufacturing line.

2. Description of Material Art

Manufacturing lines include numerous work stations that are arranged to manufacture a part or product in a sequential manner. For instance, vehicle manufacturing lines currently known and used in the art include a plurality of components such as robots arranged so as to sequentially assemble parts into a vehicle. Components may also include devices such as rails and other tooling arranged along the manufacturing line to perform a predetermined task. Such components are costly and very easily identifiable because of their size and may be used and reprogrammed to perform other tasks.

Other components are smaller and less expensive compared to the components described above. These components are created specifically for a certain manufacturing line. For instance, components known in the art as lifters are metal brackets that are mounted to a base so as to level a robot platform to a predetermined height. Another example of a hidden or small component is a bracket manufactured specifically to attach a robot platform to the floor. The design of such component is often done using software applications currently known in the art such as CAD or CATIA. Specifications relating to such components include the material stress that the component may be subjected to, the dimensions of the components, as well as 2D and 3D drawings of the components. Manufacturing lines may be formed of hundreds and thousands of components. Though components such as robots are prominently displayed along the manufacturing line and are easily identifiable, other components such as lifters, brackets, and the like are often hidden from view or not easily seen as they are relatively small in comparison to the robots.

The manufacturing line may include thousands of such brackets. The cost of a single bracket relative to a robot is very inexpensive. For instance, a lifter may cost $30, whereas a robot may cost $100,000. There may be numerous lifters within a manufacturing line and identifying lifters from existing lines that may be used to produce a new manufacturing line is desirable from a cost savings and material savings perspective. However, it is often difficult to identify minor components from preexisting lines as the identification of such an item may require at certain times the disassembly of the entire line. Furthermore, the minor components are typically sold off for scrap metal because the time and effort required to isolate and identify these minor components do not outweigh the cost savings in reusing the material. For example, a manufacturing line may have a thousand lifters and twenty thousand of the same bracket. Thus, without a system that identifies and locates the desired component in an existing line, hundreds of man hours will have to be spent disassembling the manufacturing line, inventorying the components, gathering the specification for each component, and comparing the specification and drawings of each component of a preexisting line with the specifications and needs of the retooled or newly produced manufacturing line. This may take weeks and thousands of man hours, as opposed to just paying $100,000 to manufacture components such as lifters and brackets for the new assembly line. Furthermore, current practice is to offset the cost of manufacturing new components by selling an existing line as scrap metal.

Accordingly, it remains desirable to have a system and method for managing materials when retooling and producing a manufacturing line so that minor components may be utilized in existing manufacturing lines that are no longer functioning. Utilizing existing components reduces the cost of retooling and producing a new manufacturing line.

### SUMMARY OF THE PRESENT INVENTION

The present invention provides a system and method for material management. More specifically, the system and method reduces the cost of retooling and producing a manufacturing line by using compatible components of an existing manufacturing line. The system includes an inventory. The inventory includes a list of the components which form the manufacturing line. The inventory may also include the specifications of each of the existing components. The inventory and specifications of the existing components are stored in a database. The database is in communication with a display.

The system further includes a first processor in communication with the database and the display. The first processor is operable to process the database to identify each component that is stored therein. The system may further include an interface. The interface is in communication with the first processor and the display. The interface is operable to provide information to the first processor relating to the specification of components needed to configure a new manufacturing line. The first processor processes the information so as to generate a list of compatible components. The list of compatible components includes each component from any one of the existing manufacturing lines that may be used to assemble the new manufacturing line based upon the specifications of the desired component. The first processor may further process the list of compatible components so as to show the list of compatible components on the display.

The server may be in communication with a plurality of work stations, each of the work stations located remotely from the other. The server may be connected to the work stations through a local area network, a wide area network, or the like. The work stations include a second processor and an interface. The interface is in communication with the second processor, and the second processor is in communication with the first processor. The second processor processes information from the interface so as to actuate the first processor and deliver information from the database. For instance, the interface may actuate the second processor so as to perform a desired task such as identifying components from an existing manufacturing line that may be used in the new manufacturing line. The second processor gathers information from the interface such as the specification of the desired component, the specification of the new manufacturing line, the component number, and the like. The second processor communicates this information to the first processor. The first processor then processes the database so as to identify components in the inventory which are compatible with the specifications provided by the interface. The compatible components are compiled into a list of compatible components and shown on the display.

The system may include a computer system executing a software program. The software program includes segments. The segments are a series of executable steps directed towards accomplishing a predetermined task. One segment may be directed towards storing and updating the inventory in the database. The software application also includes a segment which associates each of the components in the inventory with the specification of the components and processes the plurality of inventories to determine if any of the components of the preexisting manufacturing line is the same as any of the components of the predetermined manufacturing line. Yet another segment processes the specifications of each of the components of the predetermined manufacturing line and locates all of the components of any of the preexisting manufacturing lines that meet the specifications of any of the components in the component list. The software application then generates a list of all components from any of the preexisting manufacturing lines that meet the specification of any one of the components in the component list so as to provide a list of used components suitable for use in the predetermined manufacturing line.

A material management method for producing a manufacturing line is also provided herein. The method includes the steps of determining the components of the predetermined manufacturing line and gathering the specifications of the components for the predetermined manufacturing line. The method also includes the step of populating a database with inventories. Each of the inventories includes a list of components of preexisting manufacturing lines and provides the specifications for each of the components in the inventory. The method then proceeds to the step of processing the list of inventories so as to identify components in each of the preexisting manufacturing lines that may be used in the predetermined manufacturing line and generating a list of all components from any of the preexisting manufacturing lines that meet the specification of any one of the components in the list of needed components. Thus, the method provides a list of used components suitable for use in the predetermined manufacturing line.

### BRIEF DESCRIPTION OF THE DRAWING

A better understanding of the present invention will be had upon reference to the following detailed description when read in conjunction with the accompanying drawing wherein like references refer to like parts throughout the several views and in which:

FIG. 1 is a diagram of a system for material management;

FIG. 2 is a diagram of a database with a hierarchical structure;

FIG. 3 is an illustration of the home page of a software program for material management;

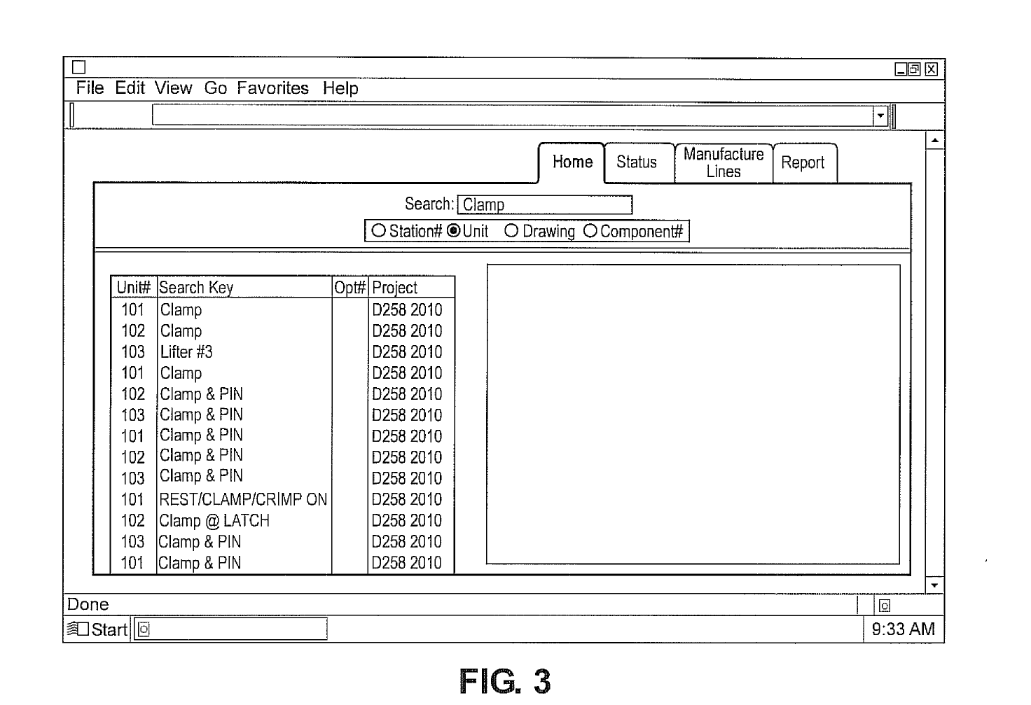

FIG. 4 is a view of FIG. 3 wherein the user selects a component based upon a keyword search;

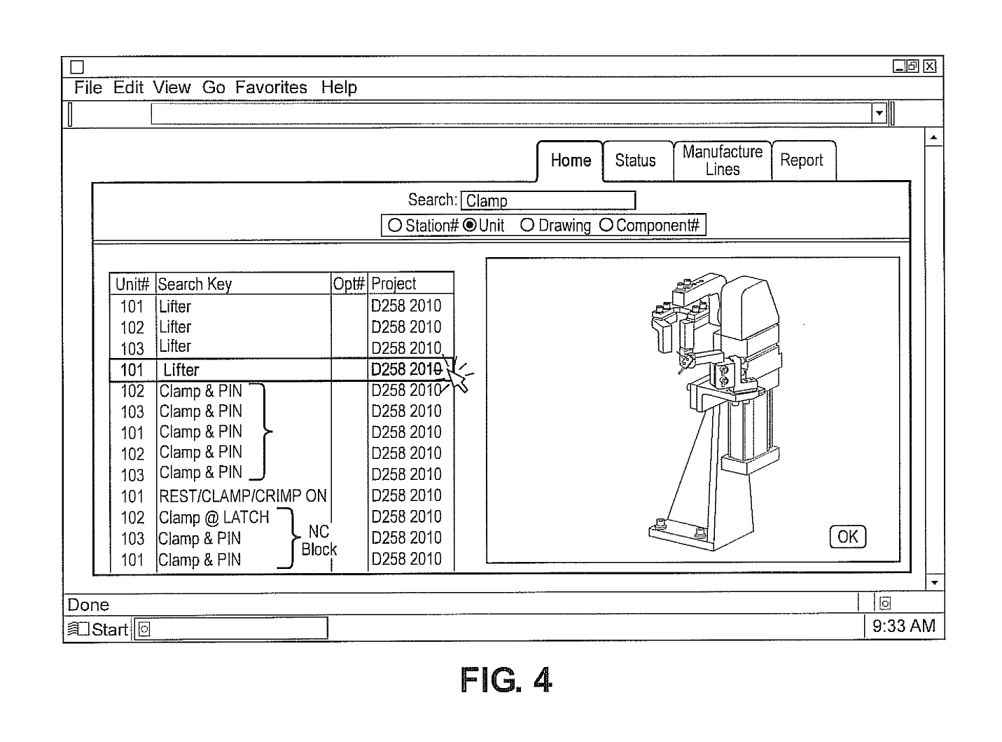

FIG. 5 is an illustration of another page of the software program for material management showing the different status reports possible; and

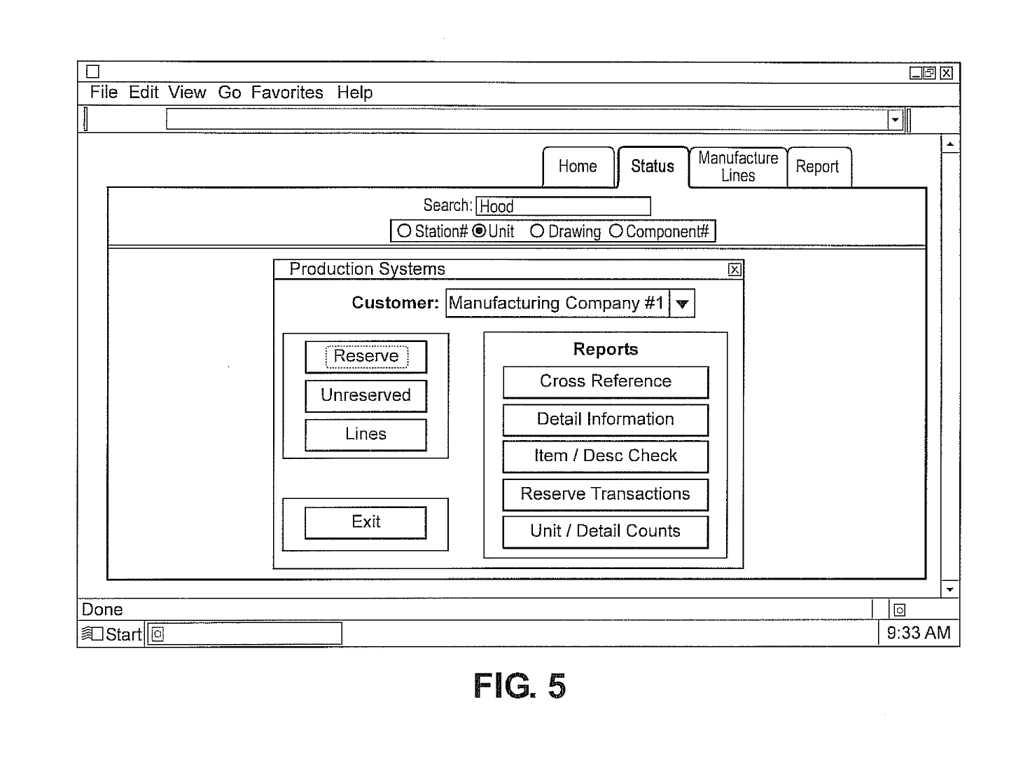

FIG. 6 is a diagram showing the steps of a method for material management.

### DETAILED DESCRIPTION OF A PREFERRED EMBODIMENT OF THE PRESENT INVENTION

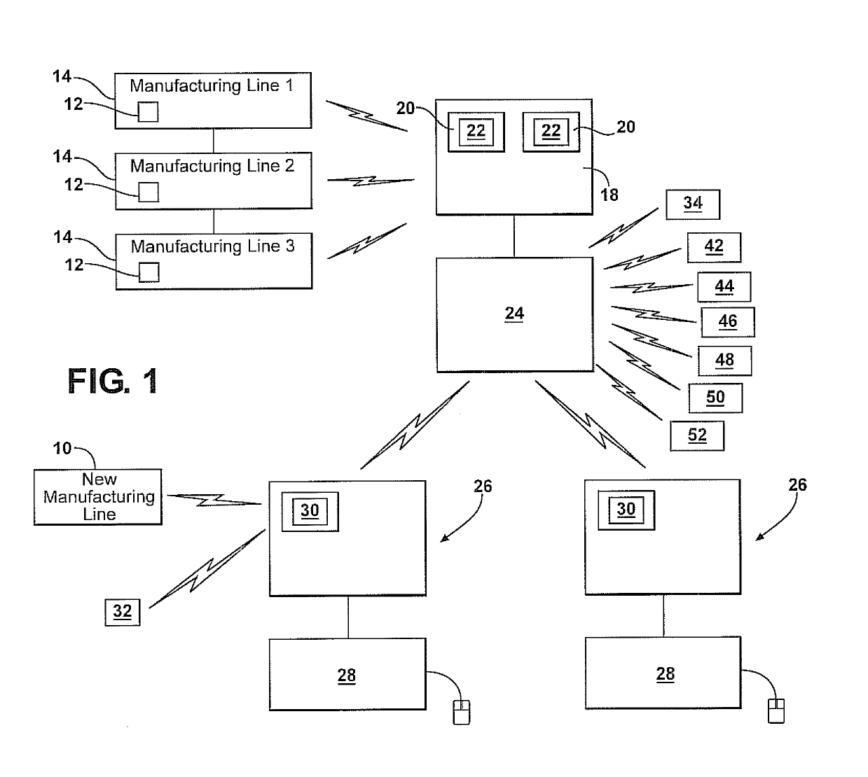

With reference first to FIG. 1, a preferred embodiment of a material management system 10 according to the present invention is illustrated. The material management system 10 utilizes components 12 from existing manufacturing lines 14 to configure a new manufacturing line 16, also referenced herein as a predetermined manufacturing line 16. The system 10 includes a database 18 storing an inventory 20 of each selected existing manufacturing lines 14. The inventory 20 includes a list of components 22 providing all of the components 12 of existing manufacturing lines 14. The database 18 is populated using design drawings and specifications of existing manufacturing lines 14. The existing manufacturing lines 14 may be tagged so as to indicate whether the existing manufacturing line 14 is scheduled to be shut down, is shut down, or is scheduled to continue operations. Each of the plurality of inventories 20 lists all of the components 12 of a preexisting manufacturing line. The specifications of each of the components 12 are also stored in the database 18 as well as drawings for each of the components 12 and other information such as the designer, revisions, and the like. The system 10 includes a first processor 24 in communication with the database 18. The first processor 24 is operable to process the database 18 so as to identify each component 12 stored therein.

The system 10 further includes at least one work station 26 having an interface 28 and a second processor 30 in communication with the first processor 24. Any processor currently known and used in the art is adaptable for use herein. The interface 28 is operable to provide information relating to the predetermined manufacturing line 16 to the second processor 30.

The interface 28 may also be used to populate the database 18 with an inventory 20 of components 12 of existing manufacturing lines 14. Additionally, the interface 28 may be used to enter desired components 12 needed for the new manufacturing line 16. Interfaces 28 are currently known and used in the art and illustratively include a keyboard, mouse, touch screen, and the like. The second processor 30 receives information from the interface 28 and processes information relating to the specification and components 12 needed to configure the new manufacturing line 16 so as to generate a list of needed components 32. The second processor 30 transmits the list of needed components 32 to the first processor 24. The first processor 24 processes the database 18 so as to generate a list of all components 12 from any of the existing manufacturing lines 14 that may be used to assemble the new manufacturing line 16. The first processor 24 compares the list of needed components 32 with the inventory 20 so as to identify each of the components 12 in the inventory 20 that may be compatible for use in the new manufacturing line 16. The first processor 24 compiles the compatible components 12 so as to generate a list of compatible components 34. The list of compatible components 34 is then transmitted to the work station 26 and shown on the display 36.

The first processor 24 may generate the list of compatible components 34 using different information provided by the interface 28. For instance, the list of compatible components 34 may be generated by the name of the component 12, by the specifications that the desired component 12 must meet, by the operation that the component 12 must perform, and the like. The first processor 24 processes the database 18 so as to identify components 12 from the inventory 20 that meet the requirements entered. For instance, a new manufacturing line 16 may require a lifter having a 5″ height and an 8×12″ base. The first processor 24 then processes the inventory 20 by looking for lifters, and once all the lifters have been identified, the first processer processes the list of lifters to find one that meets the desired specifications.

The system 10 may include a plurality of work stations located remotely from each other. Each of the work stations includes an interface 28, and a second processor 30. The second processor 30 is in communication with the first processer. Each work station is in communication with the first processor 24. The first processor 24 may be located remotely from the database 18 but is in communication with the database 18 so as to receive specifications and component details from each of the work stations 26 and process the database 18 so as to provide a list of compatible components 34 based upon the specifications received to each of the work stations 26. The database 18 may include a hierarchical structure 38. The hierarchical structure 38 has a plurality of sub-databases 40 for storing each of the specifications and its associated components 12.

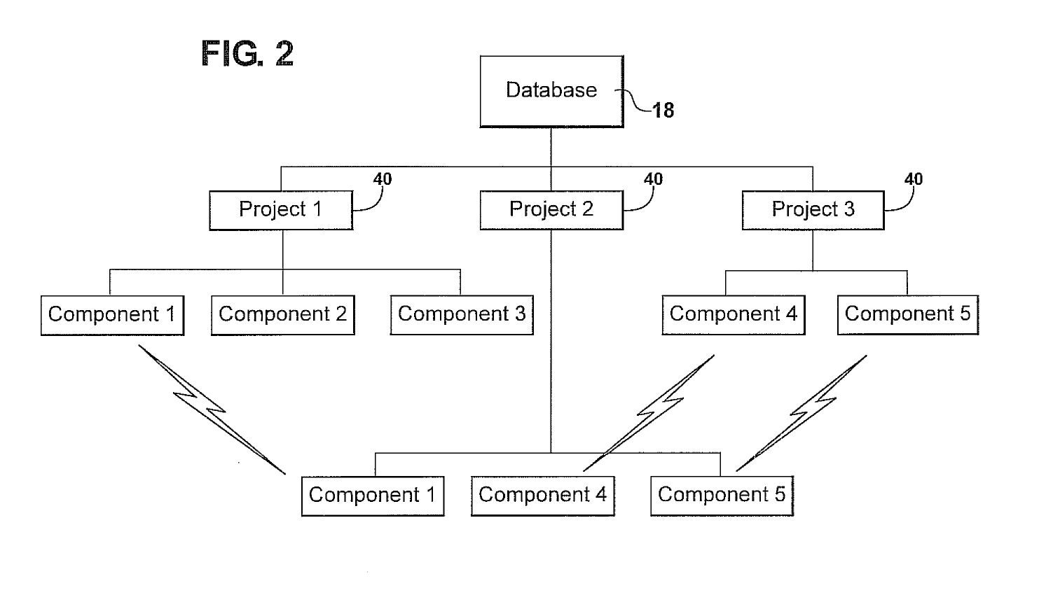

With reference now to FIG. 2, a diagram of the hierarchical structure 38 of the database 18 is provided. As shown, the components 12 may be stored in a database 18 which includes all components 12 related to a particular project. The components 12 may be grouped together into particular sub-databases 40. For instance, the components 12 may be grouped by the operation which the components 12 are assigned to do, the project the components are used in, the type of the component, or the like. With reference again to FIG. 2, the hierarchical structure 38 shows the sub-databases 40 holding components organized by the type of projects contained in the database 18. Project “1” includes components 1, 2, and 3; project “2” contains components 1, 4, and 5; project “3” contains components 4, and 5. The hierarchical structure 38 links the common components together as shown by the lightening bolt. Thus, a user searching for component 1 would learn that there are two projects which component 1 may be extracted from. It is understood that the hierarchical structure may also include sub-databases 40 which contain components based upon operating nature the component supports. For instance, sub-databases 40 may contain components based upon the use of the component to support operations such as welding, cutting, stamping, or the like. Furthermore, as is understood with hierarchical data structures, it is understood that one component 12 may be found in multiple projects or multiple operations.

The first processor 24 is operable to process the database 18 and the sub-databases 40 to identify components 12 based upon the desired operation of the predetermined manufacturing line 16 or of a component 12 of the predetermined manufacturing line 16. The interface 28 is operable to transmit to the second processor 30 a search based upon the operation of the component 12, the name of the desired component 12, the component number of the component 12, or the like. Furthermore, each component 12 of an existing manufacturing line 14 may be tagged with metadata to include terms describing the operation of the component, the component number, the project which the part or the component 12 may be associated with, and the like. Thus, the user may use the interface 28 to transmit to the processor a keyword search so as to generate a list of compatible components 34 of existing manufacturing line 14 for use in a new manufacturing line 16 based upon the keyword search.

The system 10 may also include a transfer circuit 42 in communication with the first processor. The transfer circuit 42 is operable to transfer the specifications of any of the selected components 12 to the list of compatible components 34 of the predetermined manufacturing line 16. For instance, after the user populates the database 18 with the inventory 20 of components 12 of existing manufacturing lines 14, the user may also actuate the interface 28 so as to provide the specifications of each of the components 12 in the inventory 20. Thus, the inventory 20 of components 12 is populated to include the specifications of each of the components 12 of the predetermined manufacturing line 16.

The transfer circuit 42 is operable to transfer all of the specifications of any of the selected components 12 to the list of compatible components 34. As stated above, the interface 28 may be operable to enter the desired components 12 or specifications of components 12 needed to configure the new manufacturing line 16. The information is processed by the second processor 30 and transmitted to the first processor 24. The first processor 24 processes the database 18 so as to generate a list of compatible components 34. Specifically, the first processor 24 searches the database 18 to locate any components in any inventory 20 that is adaptable for use as any one component in the list of needed components 32. The interface 28 is further operable to selectively choose any component 12 from the list of existing components 12. Upon selection the interface 28 is further operable to actuate the transfer circuit 42 so as to transfer the specifications of existing components 12 to the list of needed components 32 required to configure the new manufacturing line 16.

The system 10 may also include a locating circuit 44 in communication with the first processor 24. As stated above, part of the issue with using components 12 from existing manufacturing lines 14 is locating the existing component. Existing manufacturing lines 14 may include hundreds of robots and literally hundreds of thousands of components 12 arranged over a few hundred yards. Thus, even though a component 12 of an existing manufacturing line 14 may be suitable for use in a new manufacturing line 16, the use of the component 12 may be undesirable if the location of the compatible component 12 is not known. The locating circuit 44 is operable to provide the location of each of the components 12 from the list of compatible components 34 so as to facilitate the removal of selected components 12 for use in the new manufacturing line 16.

The locating circuit 44 is in communication with the first processor 24. The first processor 24 transmits to the locating circuit 44 all of the components 12 which have been selected for use in the new manufacturing line 16. The locating circuit 44 then processes the inventory 20, and more specifically the specifications of the existing manufacturing lines 14 to determine the location of each of the selected components 12. The locating circuit 44 transmits the location of each of the selected components 12 to the first processor 24. The location of each of the selected components 12 may be indicated on a drawing of the existing manufacturing line 14. Alternatively, the location of each of the selected components 12 may be provided in the design drawing of the components 12 or in the design of each existing manufacturing line 14. The locating circuit 44 facilitates the configuration of the new manufacturing line 16 as the user knows exactly where to go to extract a desired component 12.

The system 10 may also include a cost savings circuit 46. The cost savings circuit 46 is operable to provide the expense of extracting selected components 12 from existing manufacturing lines 14, and the cost of purchasing new components 12 for use in the new manufacturing line 16. The user may compare the cost between the two different options to determine which option is preferable. The cost savings circuit 46 is in communication with the first processor 24. The first processor 24 transmits to the cost savings circuit 46 each of the components 12 selected for use in the new manufacturing line 16. The cost savings circuit 46 is operable to determine the cost of extracting the selected components 12 from existing manufacturing lines 14 by processing the specifications and of the component 12 and the existing manufacturing line 14 to determine the number of man hours and tooling required to extract a specific component 12.

The cost savings circuit 46 is also in communication with the display 36, and may include a series of inquiries directed towards obtaining information related to extracting a particular component 12. For instance, cost savings circuit 46 may prompt the display 36 to ask the user how many man hours is required to remove a particular component 12, and the hourly wage of the laborer. The cost savings circuit 46 may also prompt the display 36 to ask how much a particular component 12 costs to purchase. The cost savings circuit 46 may then further process the list of selected components 12 and provides the total cost for purchasing all of the selected components 12. The cost savings circuit 46 may break down the total costs by a particular component 12. Thus, if the new manufacturing line 16 requires 10,000 lifters, and the cost for purchasing a new lifter is $30 USD, and the cost for purchasing all of the selected components 12 adaptable for use in the predetermined manufacturing line 16 is two million U.S. Dollars, the costs savings circuit will show that of the two million dollars, $300,000 is attributed to the cost of lifters. Thus, the user is able to compare the cost of extracting a particular component 12 from an existing manufacturing line 14 with the cost of purchasing a new component 12.

The system 10 further includes a filter 48 operable to process the list of compatible components 34 so as to sort the list 34 by the most suitable components 12 in the list. The filter 48 is operable to filter 48 the generated list of all components 12 of existing manufacturing lines 14 so as to sort them by suitability. Thus, the system 10 facilitates the production of a predetermined manufacturing line 16 by focusing the user on results which are most suitable based upon the specifications of the components 12 in the components 12 list and the needs and operations of the predetermined manufacturing line 16. For instance, some of the components in the list of compatible components 34 may have more structural strength than others, but may require minor alteration. The user is able to select which is more desirable, i.e. structural strength or a component requiring no alteration. Based upon the desired attribute, the filter will process the list 34 and rank the most desirable first in the last 34.

The system 10 may further include a status circuit 50 in communication with the processor. The status circuit 50 is operable to process the database 18 so as to determine the status of each component 12 of any of the preexisting machines in the database 18. The status circuit 50 identifies the status of a particular component 12. For instance, the status circuit 50 may identify whether or not a component 12 has been selected for use in a predetermined manufacturing line 16, has already been used in a preexisting manufacturing line, or whether the component 12 is available for use. Thus, as the user selectively chooses components 12 for use in the predetermined manufacturing line 16, the status circuit 50 labels the selected component 12 as being reserved. In addition, if a component 12 has been used, the status circuit 50 is operable to label the component 12 as having been used and provides this information to the user so that the user can easily see the status of all components 12 in any of the existing manufacturing lines 14. Thus, the status circuit 50 helps users determine whether or not a compatible component 12 of an existing manufacturing line 14 should be used in a new manufacturing line 16 by giving users a general indication of how much use the compatible component 12 has endured. Thus, if the status circuit 50 indicates that a particular component 12 has been used in two different existing manufacturing lines 14 the user may want to retire the component 12 or sell the component 12 for scrap metal.

The system 10 may further include a reporting circuit 52 in communication with the first processor 24. The first processor 24 is operable to actuate the reporting circuit 52 so as to generate a report. The report may be customized to include selected information. For instance, the report may include information relating to the specifications of the component 12, the number of particular components 12 in the list of components 22, and each of the components 12 from the existing manufacturing line 14 that have been selected for use in the predetermined manufacturing line 16.

In a first preferred embodiment the system 10 is a web-based system 54 having a database 18 and a server. The server 57 is in communication with the database 18 and a plurality of work stations. The server 57 is operable to place each of the plurality of work stations 26 in communication with each other and with the database 18. The system 10 includes a computer system 10 which executes a software program.

The software program includes a plurality of segments 56 for performing specific tasks. One of the segments 56 stores the inventory 20, and the list of compatible components 34 of existing manufacturing lines 14 in the database 18. The software application segment 56 also associates each of the components 12 in the inventory 20 with the specifications of each of the components 12. Yet another software segment 56 processes the plurality of inventories 20 to determine if any of the components 12 of an existing manufacturing line 14, is the same as any of the components 12 needed in the new manufacturing line 16.

The software program also includes a segment 56 that processes the specifications of each of the components 12 of the new manufacturing line 16 and locates all the components 12 of any of the existing manufacturing lines 14 that meets the specifications of any one of the components 12 in any one of the new manufacturing lines 16. The software application also includes a segment 56 for generating a list of all components 12 from any of the existing manufacturing lines 14 that meet the specifications of any of the components 12 in the list of needed components 32 so as to provide a list of compatible components 34 suitable for use in the new manufacturing line 16.

Yet another segment 56 of the software program creates a hierarchical structure 38 having a plurality of sub-databases 40. The segment 56 is operable to identify components 12 of the existing manufacturing lines 14 based upon the desired operation of the predetermined manufacturing line 16. The segment 56 may further place components 12 of existing manufacturing lines 14 in sub-databases 40 based upon the name of the particular component 12, the function of a particular component 12, the component's 12 identification number, or the project for which the component 12 is to be used.

The software application is operable to receive transmissions from the interface 28 so as to search and locate each of the components 12 in the database 18 based upon the specifications, operations, or keyword search entered into. The software application includes a segment 56 that generates a list based upon the transmission received through the interface 28, and the interface 28 is further operable to selectively choose each of the components 12 in the generated list. The software application includes a segment 56 which is operable to capture each of the selected components 12 and transfer the specifications of the selected components 12 and the components 12 to the list of compatible components 34 of the predetermined manufacturing line 16.

The software program includes a segment 56 that processes the list of compatible components 34 so as to sort the list in the order of the most suitable component 12 for use in the new manufacturing line 16. The software program also includes a segment 56 which is operable to process the list of compatible components 34 so as to determine any specifications, parts, and component 12 numbers which have not yet been selected. The software program further includes a segment 56 that identifies each of the components 12 as being available for use, is already selected for use in the predetermined manufacturing line 16, or has already been used in one of the existing manufacturing lines 14. Thus, the software program provides notice of the availability of each of the components 12 selected so as to avoid conflict with a desired component 12 of an existing assembly line 14 which has already been selected for a different new manufacturing line 16, or that is part of an existing manufacturing line 14 that is currently operating. Namely, the software program provides each user at a work station 26 with knowledge of the status of a particular component 12 so that the predetermined manufacturing line 16 may be produced without interfering with the production of an existing manufacturing line 14 that is currently operating.

The software program further includes a segment 56 that generates a report. The report can include information relating to the specifications of the components 12, the number of a particular component 12 in the list of components 22, and each of the components 12 from an existing manufacturing line 14 that has been selected for use in the predetermined manufacturing line 16. Thus, the report is beneficial for analyzing material management savings and cost savings based upon the use of components 12 in existing manufacturing lines 14 for implementation in the new manufacturing line 16. The report may also include cross referencing, namely the other components 12 which are associated or are otherwise interconnected with the selected component 12. Thus, the user is able to determine the components 12 affected by the selected component 12 so as to ensure that the selected component 12 is adaptable for use in the manufacturing line as a whole.

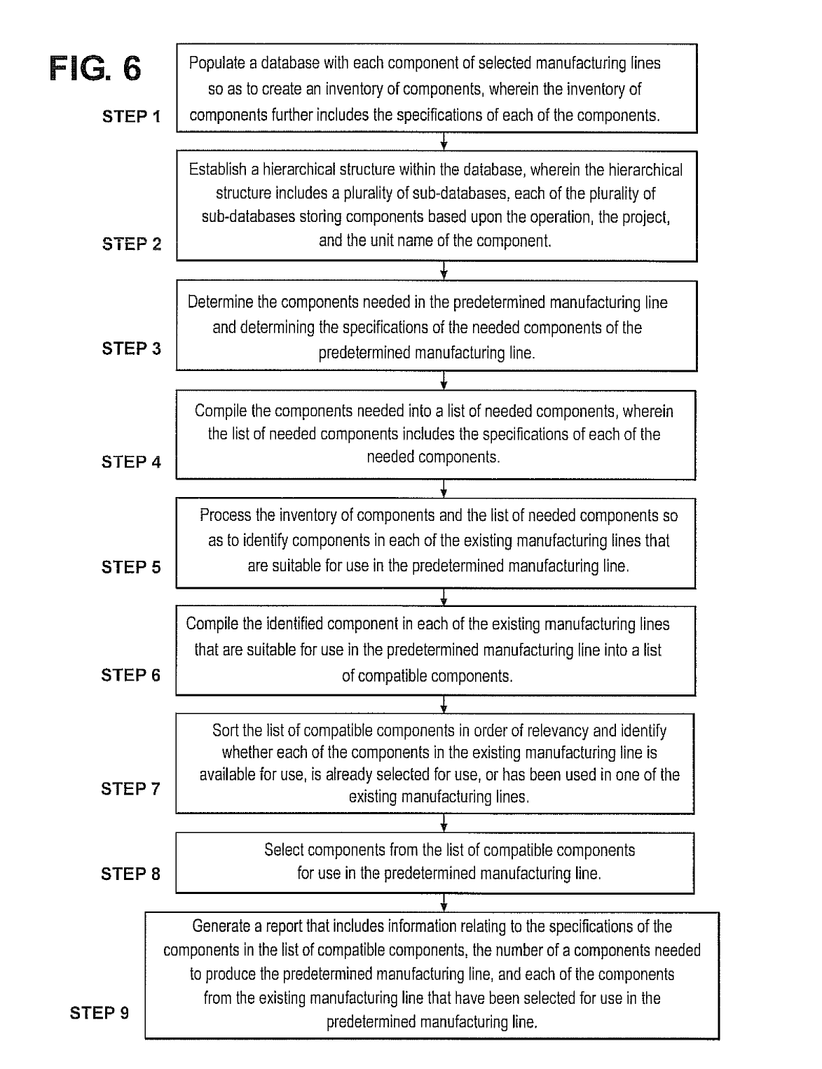

With reference now to FIG. 6, a cost savings method 58 for producing a predetermined manufacturing line 16 is provided. The method 58 begins by populating the database 18 with each component 12 of any selected existing manufacturing lines 14 so as to create an inventory 20 of components 12. The inventory 20 may also include the specifications of each of the components 12. The method 58 includes the steps of determining the components 12 needed in a new manufacturing line 16 and determining the specifications of the needed components 12 of the new manufacturing line 16. The needed components 12 are compiled into a list of needed components 32, wherein the specifications of each of the needed components 12 are available.

The next step in the method 58 is to process the inventory 20 so as to identify components 12 in each of the existing manufacturing lines 14 that are suitable for use in the new manufacturing line 16. The components 12 that are identified as being suitable for use in the new manufacturing line 16 are compiled into a list of compatible components 34. The list of compatible components 34 contain components 12 from existing manufacturing lines 14 that meet the specifications of any of the components 12 in the list of needed components 32.

The method 58 may further include the step of establishing a hierarchical structure 38 within the database 18. The hierarchical structure 38 includes a plurality of sub-databases 40 for storing components 12 based upon the operation, the project, or the unit name of the component 12. The method 58 may further include the step of filtering the list of used components 12 in order of relevancy and identifying whether each of the components 12 in the preexisting manufacturing line is available for use, is already selected for use, or has been used in one of the existing manufacturing lines 14. The method 58 can also include generating a report that includes information relating to the specifications of the components 12, the number of a particular component 12 in the in the list of components 22, and each of the components 12 from the existing manufacturing lines 14 that have been selected for use in the predetermined manufacturing line 16.

Obviously, many modifications and variations of the present invention are possible in light of the above teachings and may be practiced otherwise than as specifically described while within the scope of the appended claims.

1. A material management system operable to utilize components from at least one existing manufacturing line to configure a predetermined manufacturing line, the system comprising:
an inventory, the inventory having a list of components of the existing manufacturing lines, and the inventory includes the specification of each of the components in the list of components;
a database for storing the inventory;
a first processor in communication with the database, the first processor is operable to process the database so as to identify each component stored therein; and
an interface and a display, the interface is operable to provide information needed to configure the predetermined manufacturing line to the first processor so as to generate a list of needed components, and the list of needed components includes all of the components needed to configure the new manufacturing line, and the first processor is operable to process the inventory and the list of needed components so as to identify all components in the inventory which are compatible for use in the predetermined manufacturing line and generate a list of compatible components, and the list of compatible components includes all components in the inventory which are compatible for use in the predetermined manufacturing line, and the first processor is operable to transmit the list of compatible components to the display so as to display the list of compatible components, and the interface is operable to selectively choose any component from the list of compatible components for use in the predetermined manufacturing line.

2. The material management system as set forth in claim 1, further including at least one work station, each of the at least one work station is remotely located from the other, and each of the at least one work station includes the interface, the display, and a second processor in communication with the first processor, and each of the at least one interface is operable to provide information relating to the predetermined manufacturing line to the second processor, and the second processor processes the information and transmits the information to the first processor.

3. The material management system as set forth in claim 1, further including a cost savings circuit in communication with the first processor, the first processor transmits each of the components selected for use in the new manufacturing line to the cost savings circuit, and the cost savings circuit is operable to compare the cost of purchasing new components with the cost of extracting the selected components from any one of the at least one existing manufacturing lines.

4. The material management system as set forth in claim 1, wherein the database is configured in a hierarchical structure, the hierarchical structure having a plurality of sub-databases for storing predetermined components.

5. The material management system as set forth in claim 4, wherein each of the plurality of sub-databases are configured to store components based upon one category selected from the group of categories comprising: the part number of the component, the project with which the component is associated with, the operation of the component, and the name of the component.

6. The material management system as set forth in claim 1, further including a transfer circuit in communication with the first processor, the transfer circuit is operable to transfer any of the selected components to from the list of compatible components to the list of needed components of the predetermined manufacturing line.

7. The material management system as set forth in claim 1, further including a locating circuit in communication with the first processor, the locating circuit is operable to provide the location of each of the components from the list of compatible components so as to facilitate the removal of selected components for use in the predetermined manufacturing line.

8. The material management system as set forth in claim 1, further including a filter operable to process the list of compatible components so as to sort the list of compatible components by the most suitable components.

9. The material management system as set forth in claim 1, further including a status circuit in communication with the first processor, the status circuit is operable to process the database so as to determine the status of each component of any of the preexisting machines in the database, and the status circuit is operable to label each component with one status selected from the group comprising: the component is already selected for use in a predetermined manufacturing line, the component is available for use in a predetermined manufacturing line, and the component has been used in more than one existing manufacturing line.

10. The material management system as set forth in claim 1, further including a reporting circuit in communication with the first processor, the first processor is operable to actuate the reporting circuit so as to generate a report, and the report is customized to include selectable information from the group of information comprising: the specifications of the component, the number of particular components in the list of needed components, and each of the components from the preexisting manufacturing line that have been selected for use in the predetermined manufacturing line.

11. The material management system as set forth in claim 1, wherein the system is a web-based system having at least one computer system executing a software program, the web-based system in communication with the database, the web-based system further including a server, and the server is in communication with the database and a plurality of work stations, and the server is operable to place each of the plurality of work stations in communication with each other and with the database.

12. The material management system as set forth in claim 11, wherein the software program includes a plurality of segments for performing specific tasks, and in one of the plurality of segments stores the inventory and the list of compatible components of existing manufacturing lines in the database, another of the plurality of segments associates each of component in the inventory with the specifications of each of the components, another of the plurality of segments processes the plurality of inventories to determine if any of the components of an existing manufacturing line is similar with any of the components needed in the predetermined manufacturing line, another of the plurality of segments that processes the specifications of each of the components of the predetermined manufacturing line and locates all the components in any of the at least one existing manufacturing lines that meets the specifications of any one of the components the predetermined manufacturing line, another of the plurality of segments generates a list of all components from any of the existing manufacturing lines that meet the specifications of any of the components in the component list so as to provide a list of used components suitable for use in the predetermined manufacturing line, and another of the plurality of segments creates a hierarchical structure having a plurality of sub-databases and is operable to identify components in any one of the at least one existing manufacturing lines based upon the desired operation of the predetermined manufacturing line, and place components of existing manufacturing lines in a corresponding sub-database based upon the name of the particular component, the function of a particular component, the component's identification number, or the project for which the component is used.

13. A method for managing materials and saving costs while producing a predetermined manufacturing line, the method comprising the steps of:
populating a database with each component of selected manufacturing lines so as to create an inventory of components, and the inventory of components further includes the specifications of each of the components;
determining the components needed in the predetermined manufacturing line and determining the specifications of the needed components of the predetermined manufacturing line;
compiling the components needed into a list of needed components, and the list of needed components includes the specifications of each of the needed components;
processing the inventory of components and the list of needed components so as to identify components in each of the existing manufacturing lines that are suitable for use in the predetermined manufacturing line;
compiling the identified component in each of the existing manufacturing lines that are suitable for use in the predetermined manufacturing line into a list of compatible components, and the list of compatible components contain components from existing manufacturing lines that meet the specifications of any of the components in the list of needed components; and
selecting components from the list of compatible components for use in the predetermined manufacturing line.

14. The method as set forth in claim 13, further including the step of establishing a hierarchical structure within the database, and the hierarchical structure includes a plurality of sub-databases, each of the plurality of sub-databases storing components based upon the operation, the project, and the unit name of the component.

15. The method as set forth in claim 14, further including the step of sorting the list of compatible components in order of relevancy and identifying whether each of the components in the existing manufacturing line is available for use, is already selected for use, or has been used in one of the preexisting manufacturing lines.

16. The method as set forth in claim 15, further including the step of generating a report that includes information relating to the specifications of the components needed to produce the predetermined manufacturing line, the number of components needed to produce the predetermined manufacturing line, and each of the components from the any one of the at least one existing manufacturing lines that have been selected for use in the predetermined manufacturing line.
